(19) United States
(12) Patent Application Publication
(10) Pub. No.: US 2006/0066725 A1
(43) Pub. Date: Mar. 30, 2006

(54) Method and apparatus for controlling a video surveillance camera

(75) Inventors: Albert T. Dodrill, Pomona, NY (US); Evghenii Croitor, Brooklyn, NY (US); Eugene Ryman, Oakdale, NY (US)

Correspondence Address: Gunster, Yoakley & Stewart, P.A., 500 East Broward Boulevard, Suite 1400, Fort Lauderdale, FL, 33394, US

(73) Assignee: Pelco

(21) Appl. No.: 11/233,474

(22) Filed: Sep. 22, 2005

Related U.S. Application Data
(60) Provisional application No. 60/613,191, filed on Sep. 24, 2004.

(51) Int. Cl. H04N 5/225

(52) U.S. Cl. 348/207.99

(57) ABSTRACT

An apparatus for controlling a camera in a video surveillance system comprising a camera for providing a video signal having a vertical blanking interval, a controller for controlling the camera, the controller adapted to provide control signals to the camera during a vertical blanking interval in the video signal, a transmission line having a length such that the transmission of a control signal from the controller to the camera will have a propagation delay causing the control signal to arrive at the camera outside of the vertical blanking interval, a first transmitter connected to the camera and the transmission line and a first receiver connected to the controller and the transmission line, the first transmitter providing the video signal to the transmission line and the first receiver receiving the video signal, a second transmitter connected to the controller and the transmission line, the second transmitter providing control signals from the controller to the transmission line such that the control signals do not interfere with the video signal, and a second receiver connected to the camera and the transmission line for receiving the control signals transmitted by the second transmitter, the second receiver detecting a vertical blanking interval in the video signal and providing the control signals from the transmission line to the camera during a vertical blanking interval in the video signal.

### CROSS-REFERENCE TO RELATED APPLICATION

This application claims the benefit of U.S. Provisional Application No. 60/613,191, entitled Transmitting Video Surveillance Control Signals Over a Fiber Optic Link, and filed Sep. 24, 2004. U.S. Provisional Application No. 60/613,191 is hereby incorporated by reference.

### STATEMENT REGARDING FEDERALLY SPONSORED RESEARCH OR DEVELOPMENT

N/A

### BACKGROUND OF THE INVENTION

This invention relates generally to video surveillance systems and in particular to methods of controlling video cameras in a video surveillance system.

Coaxitron® (Coaxitron is a registered trademark of Pelco) protocol is a highly effective control method for use with video cameras in video surveillance systems. In this protocol the control signals are transmitted on the same cable, such as a coaxial cable, that is utilized for transmitting the video signal thereby eliminating additional wiring costs and reliability issues. The video signal is generated by a video camera and is transmitted through the cable to a remote controlling device. The remote controlling device receives the video signal generated by the video camera and transmits control signals to the video camera by superimposing the control signals on the vertical blanking interval of the video signal so that there is no effect on the video signal when it is viewed on a monitor. The control signals are received, decoded, and executed by the video camera to effectuate the desired movement, such as panning or tilting of the camera.

Many of today's security installations requiring extremely long cable runs exceed the quality, bandwidth, and distance capabilities of standard RG-59/U coaxial cable where video and control signals start to degrade when transmitted beyond 288 meters. In addition, since the control signals in a Coaxitron protocol system are transmitted to the video camera during a specific time window in the vertical blanking period, the control signals arrive at the video camera outside of the receive time window at distances greater than approximately 288 meters.

Accordingly, there has been a long felt need for a method and system that utilizes the highly effective communication method of Coaxitron protocol at distances that exceed 288 meters.

### SUMMARY OF THE INVENTION

In accordance with the present invention there is provided an apparatus for controlling a camera in a video surveillance system comprising a camera for providing a video signal having a vertical blanking interval, a controller for controlling the camera, the controller adapted to provide control signals to the camera during a vertical blanking interval in the video signal, a transmission line having a length such that the transmission of a control signal from the controller to the camera will have a propagation delay causing the control signal to arrive at the camera outside of the vertical blanking interval, a first transmitter connected to the camera and the transmission line and a first receiver connected to the controller and the transmission line, the first transmitter providing the video signal to the transmission line and the first receiver receiving the video signal, a second transmitter connected to the controller and the transmission line, the second transmitter providing control signals from the controller to the transmission line such that the control signals do not interfere with the video signal, and a second receiver connected to the camera and the transmission line for receiving the control signals transmitted by the second transmitter, the second receiver detecting a vertical blanking interval in the video signal and providing the control signals from the transmission line to the camera during a vertical blanking interval in the video signal.

In a further aspect of the present invention there is provided a method of controlling a camera in a surveillance system wherein the camera provides a video signal having a vertical blanking interval, the controller provides a control signal to the camera during the vertical interval, and the transmission line between the controller and the camera has a length such that the propagation delay causes the control signal to arrive at the camera outside of the vertical blanking interval. The method comprises the steps of transmitting a video signal over the transmission line from the camera to the controller, providing a control signal to the transmission line during a vertical blanking interval such that the control signal does not interfere with the video signal, receiving the control signal from the transmission line, determining the occurrence of a vertical blanking interval, and providing the control signal to the camera during the vertical blanking interval.

In the present invention, the control signals are stripped, removed, or separated from the video signal at the controller, transmitted as separate data over a fiber optic cable and then synchronized and injected into the video signal at the camera end. Utilizing the present invention allows essentially unlimited transmission distances. In addition, the present invention is compliant with the standards of Coaxitron protocol control because the control signals are transmitted over the same cable as the video, i.e., no add additional wiring is required. The video and the control signals are transmitted at different wavelengths, and the video and control signals can be transmitted over one or two fibers.

Other advantages and applications of the present invention will be made apparent by the following detailed description of the preferred embodiment of the invention.

### BRIEF DESCRIPTION OF THE SEVERAL VIEWS OF THE DRAWINGS

FIG. 1 is a block diagram of a prior art video surveillance system.

FIGS. 2A-2D are exemplary signals illustrating the effect of the propagation delay as the transmission line shown in FIG. 1 increases in length.

FIG. 3 is a block diagram of a video surveillance system utilizing the present invention.

FIGS. 4A-4D are exemplary signals illustrating the signals at various locations in the video surveillance system shown in FIG. 3.

FIG. 5 is a block diagram of one embodiment of the transceiver located at the camera end of the transmission line in FIG. 3.

FIG. 6 is a block diagram of one embodiment of the transceiver located at the controller end of the transmission line in FIG. 3.

### DETAILED DESCRIPTION OF THE INVENTION

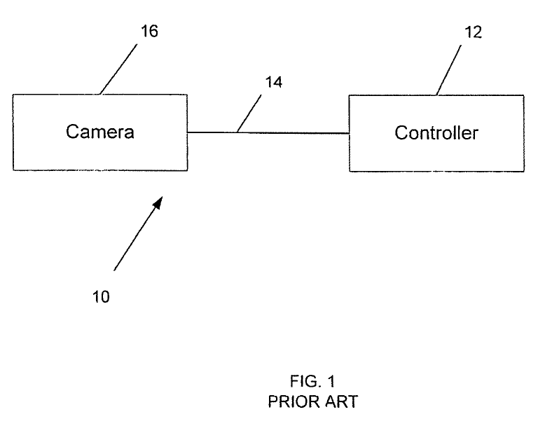

FIG. 1 shows a prior art video surveillance system 10 employing a control signal protocol in which the control signals are transmitted on the same cable as the video signals, such as the Coaxitron® (Coaxitron is a registered trademark of Pelco) protocol. Video surveillance system 10 has a controller 12 connected to a camera 14 by coaxial cable 16. Camera 14, which can be, for example, a camera, camera dome, camera and pan/tilt/lens adjust or camera and receiver/driver, provides video signals on coaxial cable 16 to controller 12. Control signals are transmitted by controller 12 on coaxial cable 16 during the vertical blanking interval of the video signal from camera 14. Controller 12 can have a monitor for viewing the video signals, or the video signal can be routed to a monitor located elsewhere.

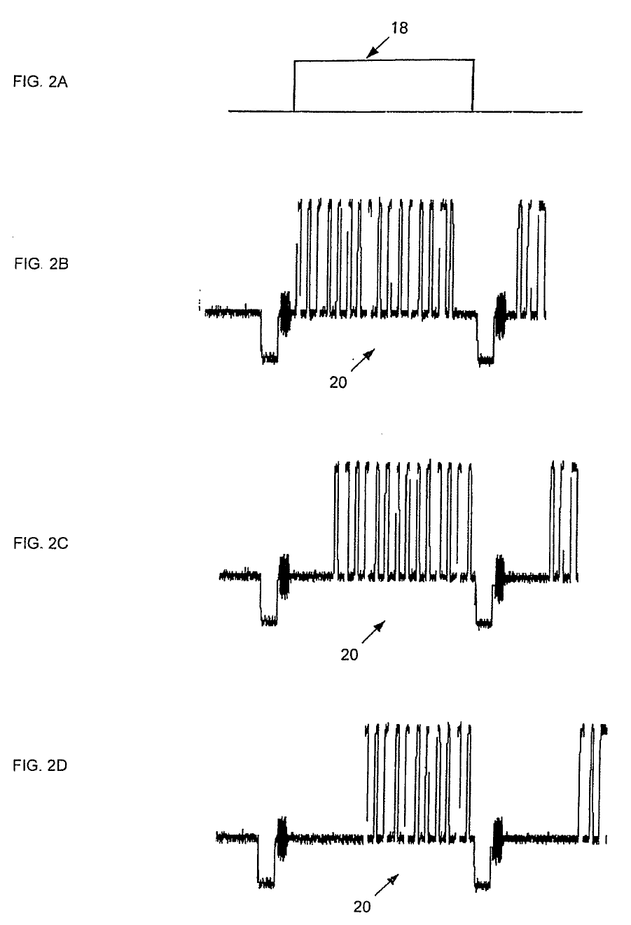

FIGS. 2A-2D illustrate the propagation delay on the control signals as the length of coaxial cable 16 increases causing the control signal to arrive outside of the vertical blanking period. FIG. 2A shows the vertical blanking window 18 of the video signal from camera 14. In FIG. 2B, the control signal indicated by numeral 20 arrives at camera 14 within vertical blanking period 18. FIG. 2C illustrates the propagation effect with a cable longer than the one shown in FIG. 2B, and 2D illustrates the propagation effect for a cable longer than the one shown in FIG. 2C. Control signal 20 in FIGS. 2C and 2D will not effectuate the desired movement in camera 14.

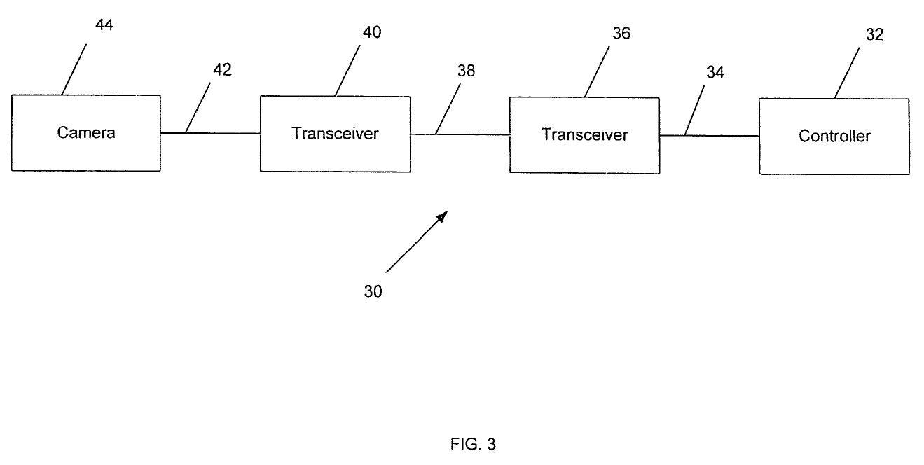

FIG. 3 illustrates a video surveillance system 30 utilizing the present invention. Video surveillance system 30 employs a control signal protocol in which the control signals are transmitted on the same cable as the video signals. Controller 32 is connected to transceiver 36 by coaxial cable 34. Transceiver 36 is connected to transceiver 40 at a remote location from controller 32 by fiber optic cable 38. Transceiver 40 is connected to camera 44 by coaxial cable 42. Camera 44 can be, for example, a camera, camera dome, camera and pan/tilt/lens adjust or camera and receiver/driver. Controller 32 can have a monitor for viewing the video signals, or the video signal can be routed to a monitor located elsewhere. The transceivers 36 and 40 can be, for example, a field-programmable gate array (FPGA) or application-specific integrated circuit (ASIC) programmable logic device (PLD), discrete components, or other circuitry techniques.

A basic Coaxitron control system consists of the controller/transmitter, coaxial cable, and receiver. The receiver can be built into the camera or can be a separate unit. The Coaxitron signals are then converted to drive voltages or relay switching for the appropriate accessory equipment controlled. The basic system can be expanded in one of two ways to control multiple camera sites with the addition of switching devices. The first way to control cameras in the multiple camera system is to select the camera signal fed to the controller/transmitter, which then feeds the monitor. When a camera selection is made, that video line is dedicated to the transmitter, which allows the associated Coaxitron receiver to be controlled. The second way in the multiple camera system is not dependent on selecting a camera to a monitor, but to select the camera for control without viewing the video, thus allowing for system level camera site control. When the camera for control selection is made the Coaxitron information is inserted in to the vertical interval without viewing the camera on the monitor, which allows the associated Coaxitron receiver to be controlled.

The control functions operate simultaneously over the same coaxial cable as the video transmission by utilizing the vertical blanking interval, during which control pulses are superimposed upon the normal video signal at a point where it is unnoticeable on the monitor. Thus, the need for additional control cables is eliminated. The basic functional concept of the Coaxitron system is that control pulses are fed in a reverse direction from the controller/transmitter to the receiver located near each camera station. These control pulses do not interfere with the video monitor presentation because they occur during the vertical blanking interval of the video signal.

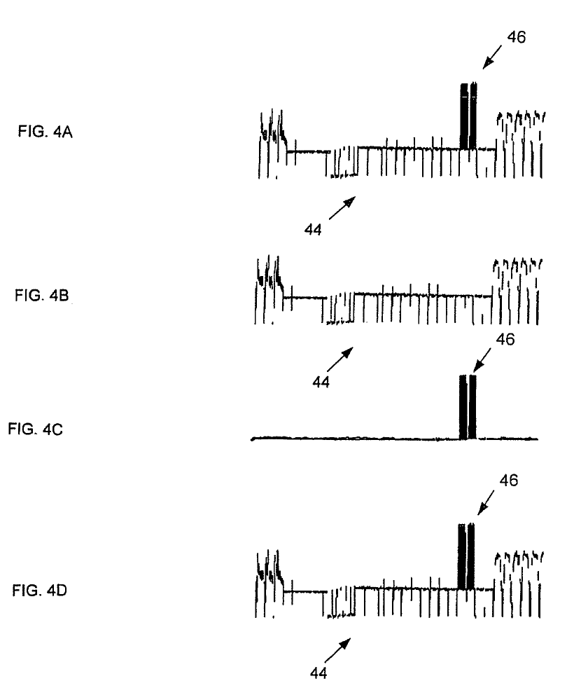

Exemplary signals at various points in video surveillance system 30 are illustrated in FIGS. 4A-4D. FIG. 4A illustrates an exemplary video signal indicated by numeral 44 with control signals, which are indicated by numeral 46. In FIG. 4A, video signal 44 is provided by transceiver 36 to controller 32, and control signal 46 is inserted during a video blanking interval by controller 32 and provided to transceiver 36. FIG. 4B illustrates an exemplary video signal 44 that is transmitted by transceiver 40 on fiber optic cable 38 to transceiver 36. FIG. 4C illustrates an exemplary control signal 46 that is transmitted by transceiver 36 on fiber optic cable 38 to transceiver 40. FIG. 4D illustrates an exemplary video signal 44 with control signal 46 inserted during a vertical blanking interval. In FIG. 4D, video signal 44 is provided by camera 44 to transceiver 40 on coaxial cable 42, and control signal 46 is inserted during the vertical blanking interval by transceiver 40 and sent to camera 44.

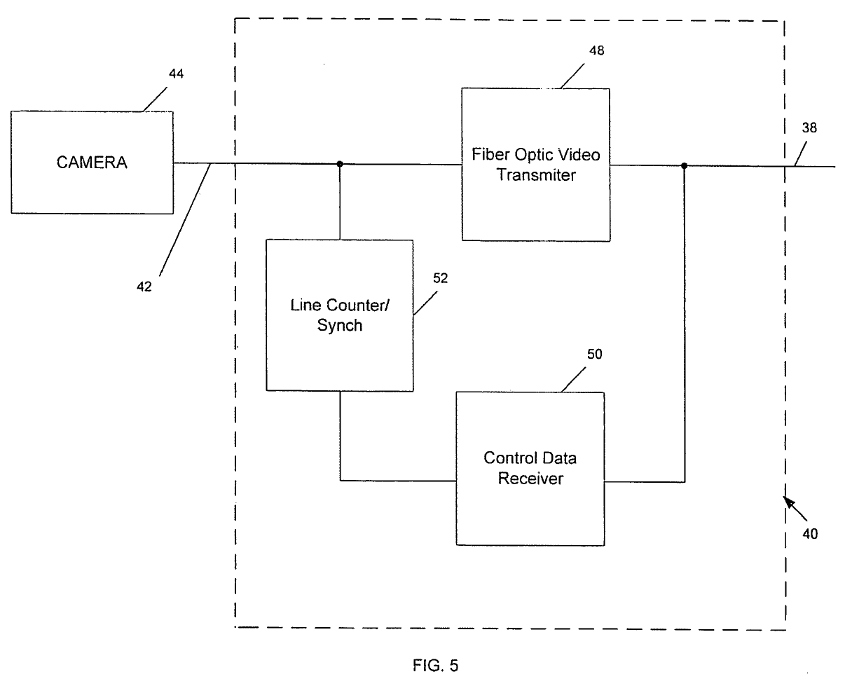

Referring to FIG. 5, a block diagram of one embodiment of transceiver 40 is illustrated. The functional blocks included in transceiver 40 are enclosed by dotted lines. The video signal from camera 44 is provided on coaxial cable 42 to fiber optic video transmitter 48, which converts the analog video signals from camera 44 to appropriate signals for fiber optic transmission and transmits those signals on fiber optic cable 38. Fiber optic control data receiver 50 receives the control signals from controller 32 and transceiver 36, which are shown in FIG. 3, and converts them to analog control signals. Fiber optic control data receiver 50 provides the control signals to line counter/synch 52, which detects the vertical blanking interval of the camera and inserts the control signals during that interval as illustrated in FIG. 4D. Video camera 44 receives the analog control signal and executes the user's command that was inputted at the controller 32.

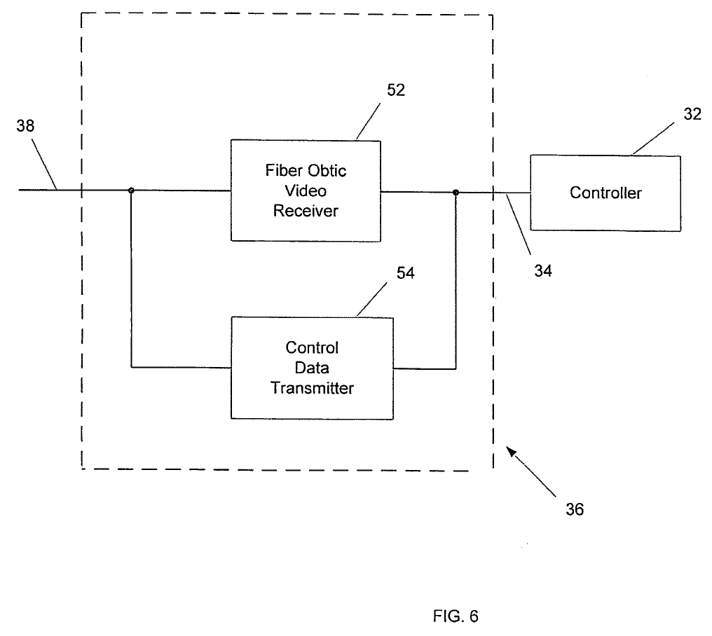

FIG. 6 illustrates a block diagram of one embodiment of transceiver 36. The functional blocks included in transceiver 36 are enclosed by dotted lines. The video signals from fiber optic cable 38 are provided to fiber optic video receiver 52 which converts the video signals back to analog. Fiber optic video receiver 52 provides the analog video signal to controller 32 via coaxial cable 34. As discussed above with reference to FIG. 3, controller 32 can have a monitor for viewing the analog video signal, or the analog video signal can be routed to a monitor located elsewhere. Controller 32 sends control signals on coaxial cable 34. Fiber optic control data transmitter 54 strips the control signals from the video signal and converts the analog control signals to signals suitable for sending as separate data over fiber optic cable 38.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the foregoing disclosure.

What is claimed is:

1. An apparatus for controlling a camera in a video surveillance system comprising: a camera for providing a video signal having a vertical blanking interval; a controller for controlling said camera, said controller adapted to provide control signals to said camera during a vertical blanking interval in said video signal; a transmission line having a length such that the transmission of a control signal from said controller to said camera will have a propagation delay causing the control signal to arrive at said camera outside of the vertical blanking interval; a first transmitter connected to said camera and said transmission line and a first receiver connected to said controller and said transmission line, said first transmitter providing said video signal to said transmission line and said first receiver receiving said video signal; a second transmitter connected to said controller and said transmission line, said second transmitter providing control signals from said controller to said transmission line such that said control signals do not interfere with said video signal; and a second receiver connected to said camera and said transmission line for receiving said control signals transmitted by said second transmitter, said second receiver detecting a vertical blanking interval in said video signal and providing the control signals from said transmission line to said camera during a vertical blanking interval in said video signal.

2. An apparatus as recited in claim 1 wherein said transmission line is a fiber optic cable and said first and second transmitters provide signals suitable for transmission on said fiber optic cable.

3. An apparatus as recited in claim 2 wherein said second transmitter transmits the control signals as separate data on said fiber optic cable.

4. An apparatus as recited in claim 2 wherein said control signals are Coaxitron type control signals.

5. An apparatus as recited in claim 1 wherein said first transmitter and said second receiver comprise a first transceiver and said second transceiver and said first receiver comprise a second transceiver.

6. An apparatus as recited in claim 3 wherein said second receiver comprises a line counter to determine the vertical blanking interval and a synchronizing circuit to synchronize the control signals with the video signal.

7. A method of controlling a camera in a surveillance system wherein the camera provides a video signal having a vertical blanking interval, the controller provides a control signal to the camera during the vertical interval, and the transmission line between the controller and the camera has a length such that the propagation delay causes the control signal to arrive at the camera outside of the vertical blanking interval, said method comprising the steps of: transmitting a video signal over the transmission line from the camera to the controller; providing a control signal to the transmission line during a vertical blanking interval such that the control signal does not interfere with the video signal; receiving the control signal from the transmission line; determining the occurrence of a vertical blanking interval; and providing the control signal to the camera during the vertical blanking interval.

8. A method as recited in claim 7 wherein said step of transmitting a video signal over the transmission line from the camera to the controller comprises converting the video signal from a first format to a second format, transmitting the video signal in the second format over the fiber optic cable, receiving the video signal from the fiber optic cable and converting the signal back to the first format.

9. A method as recited in claim 8 wherein said step of providing a control signal to said transmission line during a vertical blanking interval comprises transmitting a control signal as separate data on the fiber optic cable.

10. A method as recited in claim 9 wherein said step of transmitting a control signal as separate data on the fiber optic cable comprises transmitting Coaxitron type control signals.

11. A method as recited in claim 9 wherein said step of determining the occurrence of a vertical blanking interval comprises the step of counting video lines and said step of providing the control signal to the camera during the vertical blanking interval comprises the steps of synchronizing the control signal with the video signal and injecting the control signal into the video signal.
